(19) United States
(12) Patent Application Publication
(10) Pub. No.: US 2008/0222278 A1
(43) Pub. Date: Sep. 11, 2008

(54) System and method of global electronic job market in the Internet

(76) Inventor: V a l e n t i n a P u l n i k o v a, Villingen-Schwenningen (DE)

Correspondence Address: DR. PULNIKOVA VALENTINA, WEIHERSTRASSE 9, VILLINGEN-SCHWENNINGEN, 78050, DE

(21) Appl. No.: 11/684,622

(22) Filed: Mar. 11, 2007

(51) Int. Cl. G06F 15/173

(52) U.S. Cl. 709/223

(57) ABSTRACT

A system and a method of global electronic job market in the Internet are provided. The method of operating a global electronic job market for jobseekers and employers via the Internet includes registering the jobseekers and the employers; providing information regarding offers of the jobseekers and the employers to the registered employers and jobseekers accordingly; selecting partners in the job market based on the provided information; holding competitions for job vacancies; conducting job contracts between jobseekers and employers; providing additional services of the system of global electronic job market.

### CROSS-REFERENCE TO RELATED APPLICATIONS

This application is related to, and claims the benefit of priority to, U.S. Provisional Application No. (not yet assigned, send by mail from Germany 20.11.2006), entitled “A System and Method of Global Electronic Job Market in the Internet” by Dr. Valentina Pulnikova, the contents of which are incorporated herein by reference.

### FIELD OF INVENTION

This invention relates to the electronic job market and in particular to the global electronic job market in the Internet.

### BACKGROUND OF INVENTION

1. Description of the Related Art

At present the Internet has become one of the most popular ways for finding a job.

There are many Web sites devoted to the problem of searching for a job, such as www.monster.com, www.jobsearch.co.uk, www.jobsearch.org, www.jobbankusa.com, www.jobserve.com, www.jobpilot.net and others.

Characteristic features of these Web sites are:
a possibility to fulfil search by a jobseeker only in general;
a very poor classification of categories of employments;
searching on the basis of key words;
absence of a possibility of sorting search results,
these are mostly the national sites.

2. Problems

Analysis of patents and Web sites reveals the following main problems existing in the electronic job market.

The first problem is the absence of any classification of job positions and the absence of any classifications of specialities. A weak classification of job positions on the basis of categories of employments does not allow creating a well-structured database of offers of employers. Eventually, a search for a job on the basis of key words often gives unacceptable results.

Another problem is the absence of a well-structured database of jobseekers. In result, employers cannot fulfil a search for needed workers.

Another problem is the absence of a possibility to conduct a developed sorting of search results. Therefore, it is very difficult to find a needed result, if the large list of search results.

Another problem is the national rather then the global character of Web sites. It is impossible to get a global result on your request. This is also one of impediments for the global job market.

Another problem is the absence of a developed transaction procedure within the system of the electronic job market, which includes a negotiation procedure and a procedure for concluding job contracts.

Another problem is the absence of a possibility of inserting formal data in a database for highly qualified jobseekers.

The suggested invention solves the abovementioned problems.

### SUMMARY OF THE INVENTION

A system and a method of the global electronic job market via the Internet are proposed in this invention.

The system comprises a multilingual Web site or another network communication program, located on a host server, communication channels of the Internet and numerous computers of users. The users are jobseekers and employers, who are equitable participants of the process.

The method of the operation of the global electronic job market includes a registration block, an information block, a block of search and selection of a partner on the job market, a block of competitions for job vacancies, a transaction block and a block of additional services of the system of the global job market.

After registration, jobseekers and employers provide their offers. On the basis of these offers a database of jobseekers and a database of employers are formed and stored on a host server. The database is formed on the basis of the Global Classification of Specialities (GCS) and the Global Classification of Job Positions (GCJP). The database of jobseekers consists of two main parts. The first part of the database is formed on the basis of data obtained during the registration procedure. Another part of information about jobseekers is formed on the basis of data provided by jobseekers in the application form. These data include a name of a speciality, qualification and additional characteristics of the speciality according to GCS, a scientific degree, age, sex, a work experience, a place of residence, knowledge of languages, a required job position, according to GCJP, or a required work place, a desired salary (wage), a permanent or a temporary job needed, full-time or part-time employment needed. Jobseekers also present a Curriculum Vitae (CV) in this database. The CV can contain all the additional information about him/her, which can be interesting for employers. The database of employers also consists of the two main parts. The first part of the database of employers is also formed on the basis of data obtained during the registration procedure. Another part of information about employers is additional information about themselves. This information includes a name of a Company or another legal entity, a country, a location address, an activity category, date of foundation of the Company, a number of employees, a photograph of a Company, a Company's Web site and so on. The second part of the database of employers includes offers of employers. This information is formed on the basis of data provided by employers in the application form. These data include the name of a speciality and qualification according to GCS, offered job position according to GCJP, or a work place, a scientific degree, knowledge of languages, age, sex, a work experience, a location of the offered job, an offered salary (wage), a permanent or a casual work offered, full-time or part-time employment offered and additional characteristics of the speciality suggested by the system.

Jobseekers and employers can access this database and conduct needed searching. Jobseekers implement searching with the aim to find a needed job. Employers carry out searching with the aim to find needed employees. Jobseekers and employers can perform a different sorting of search results. Upon a request of a jobseeker or an employer, a selection of desired job positions or employees can be made. A result of selection becomes available to the user.

After analysis of the acquired information, the potential partners can negotiate in the frame of the system of the global electronic job market or outside it.

The jobseekers and employers can conclude a job contract either in the frame of the system or outside the system. If the job contract is concluded within the frame of the system a number of typical contracts are offered. The contract is stored in the database for a stipulated time.

Besides, the system of electronic job market offers holding a competition for job vacancies.

The system of electronic job market further offers additional services including a detailed help for working in the system with a number of examples, “Hot-line” with a consultation about the work of the system of electronic job market, juridical services dealing with problems of electronic job market, an analysis and prognosis of the job market, if required by Companies, other organizations and individuals, an analysis and prognosis of the a specific branch of the job market and a publication of the magazine with an analysis of the global electronic job market.

### BRIEF DESCRIPTION OF THE DRAWINGS

FIG. 1 is a principal scheme of the system of global job market.

FIG. 2 is a principal scheme of the method of operation of global job market.

FIG. 3 is a detailed description of the registration block.

FIG. 4 discloses the process of creating the database of jobseekers.

FIG. 5 discloses the process of creating the database of employers.

FIG. 6 discloses the process of searching for a needed job by a jobseeker.

FIG. 7 discloses the process of searching for needed employees by an employer.

FIG. 8 discloses the process of searching for a needed job by a jobseeker on the basis of an expanded request.

FIG. 9 discloses the process of searching for needed employees by an employer on the basis of an expanded request.

FIG. 10 shows a detailed description of the transaction block.

FIG. 11 shows a detailed description of the process of concluding of job contracts.

FIG. 12 shows a detailed description of the process of a competition for job vacancies.

FIG. 13 shows additional services of the system of global job market.

### DETAILED DESCRIPTION

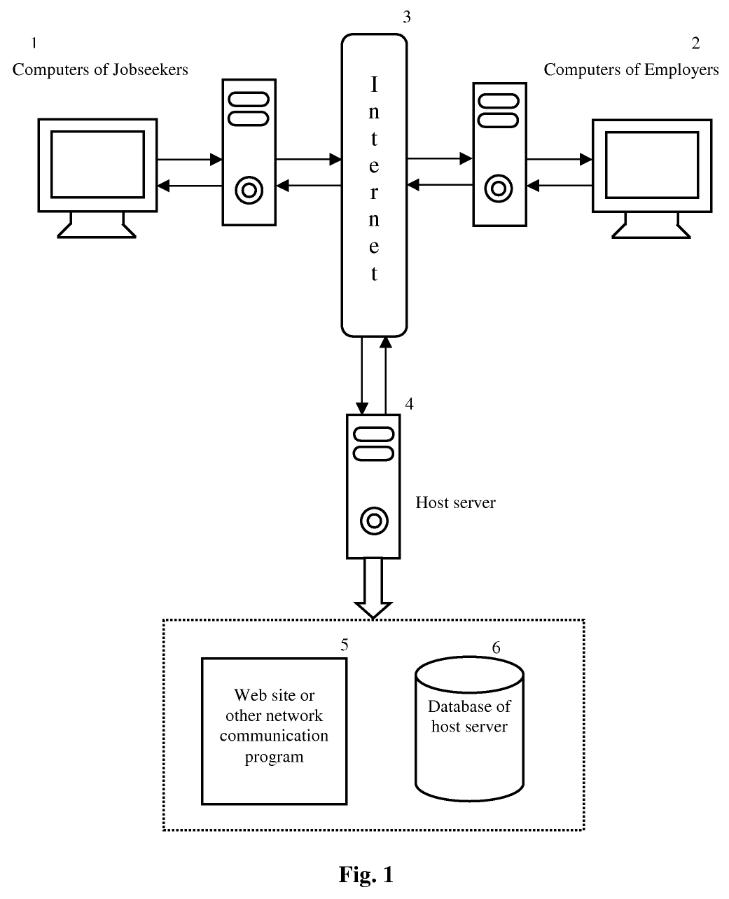

A system of global electronic job market for users including employers and jobseekers (FIG. 1) comprises user computers for employers 2 and jobseekers 1 interacting via the Internet 3 with a Web site or another network communication program 5 located on a host server 4; a database 6 including requests of jobseekers for job searching and offers of employers and located on the host server; and the Internet and/or other communication networks 3.

Users can access the Web site from their computers by means of the Internet Explorer or another Web browser. Jobseekers can acquire information about employers and which employees are they searching for. Employers can acquire information about jobseekers. After entering the main page of the Web site a user can work either as a registered user or in a free access mode. In the free access mode the user can:
get acquainted with the rules of working within the system and access other official regulating documents of the system available in different world languages;
familiarize himself with the registration procedure;
familiarize himself with sections of jobseekers and employers, access requests of jobseekers and offers of employers;
get familiar with the structure of the site, and so on.
   The system does not grant an access to the data of jobseekers or employers for unregistered users.

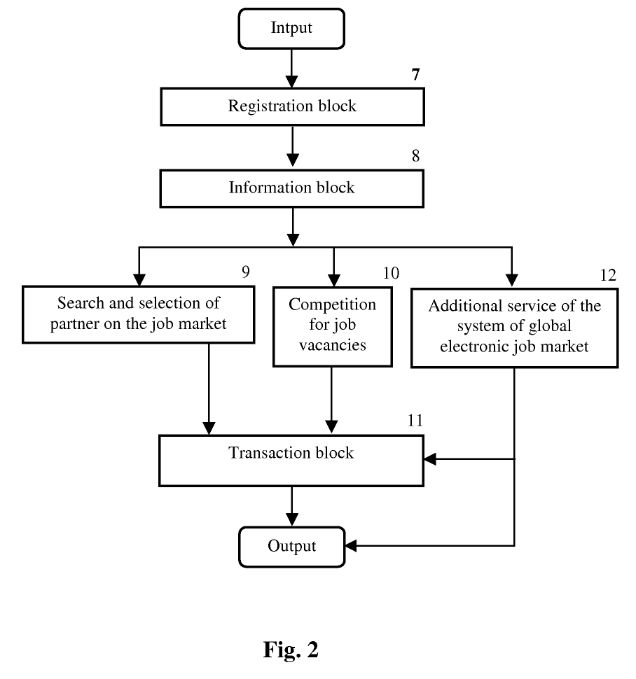

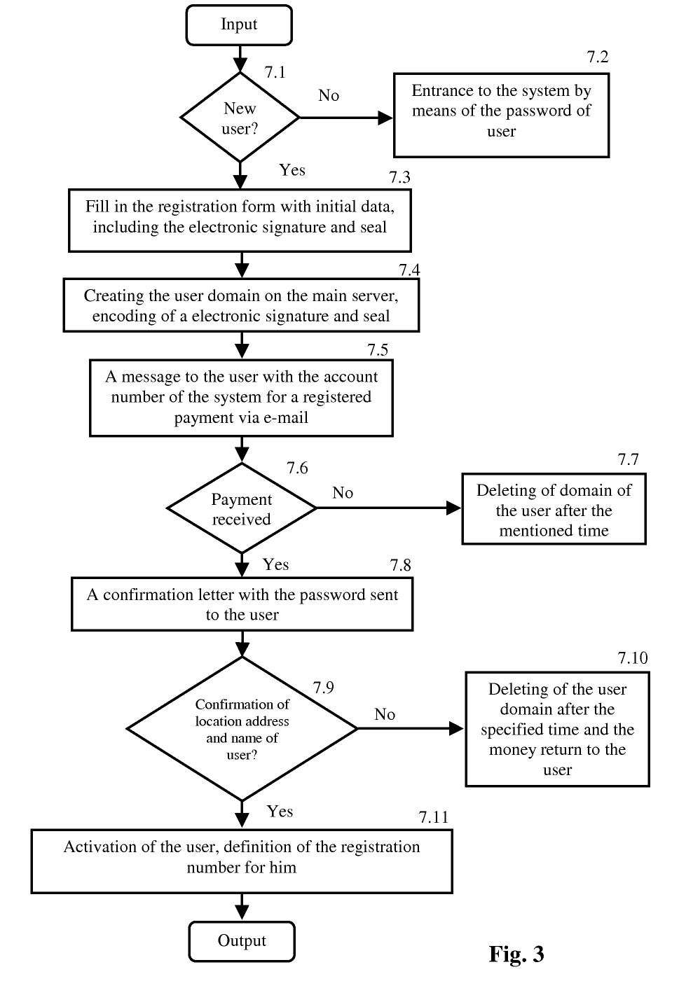

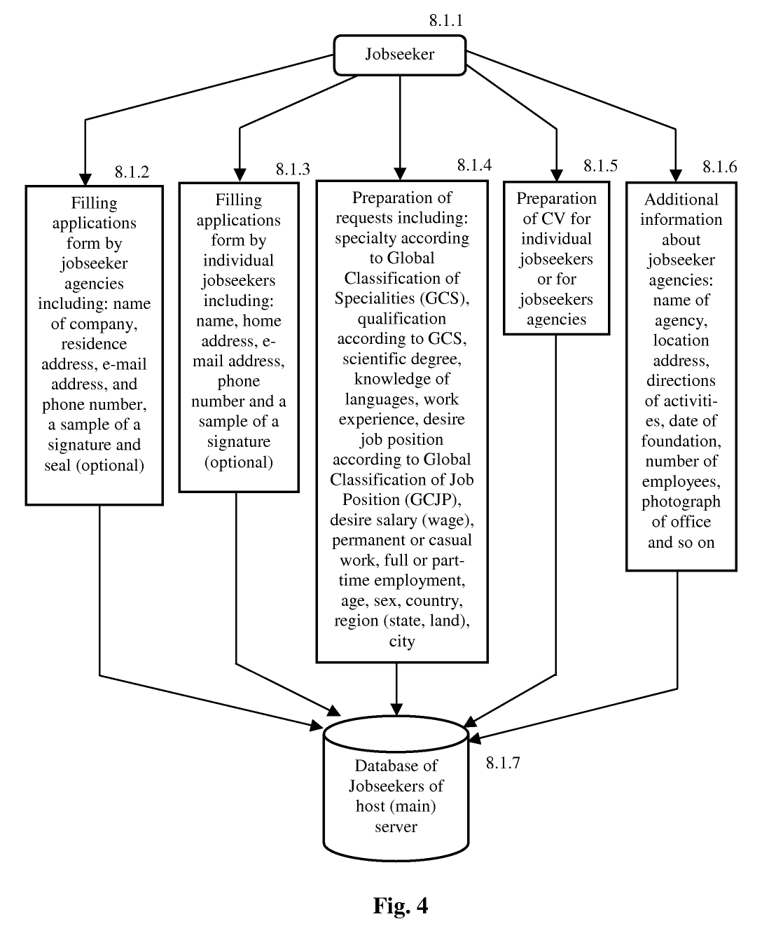

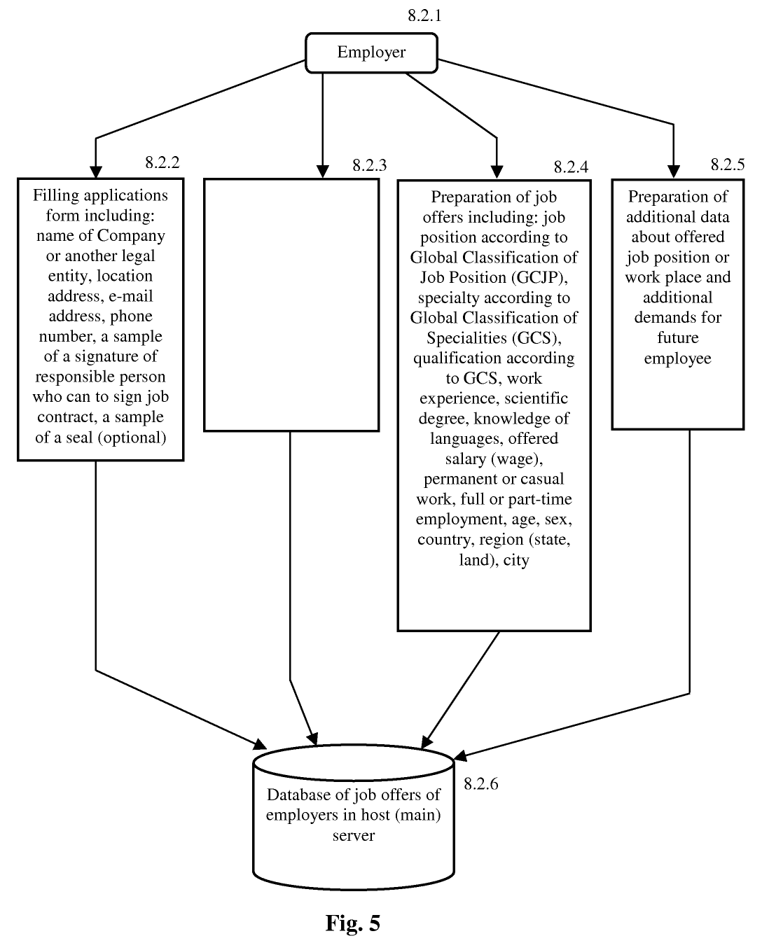

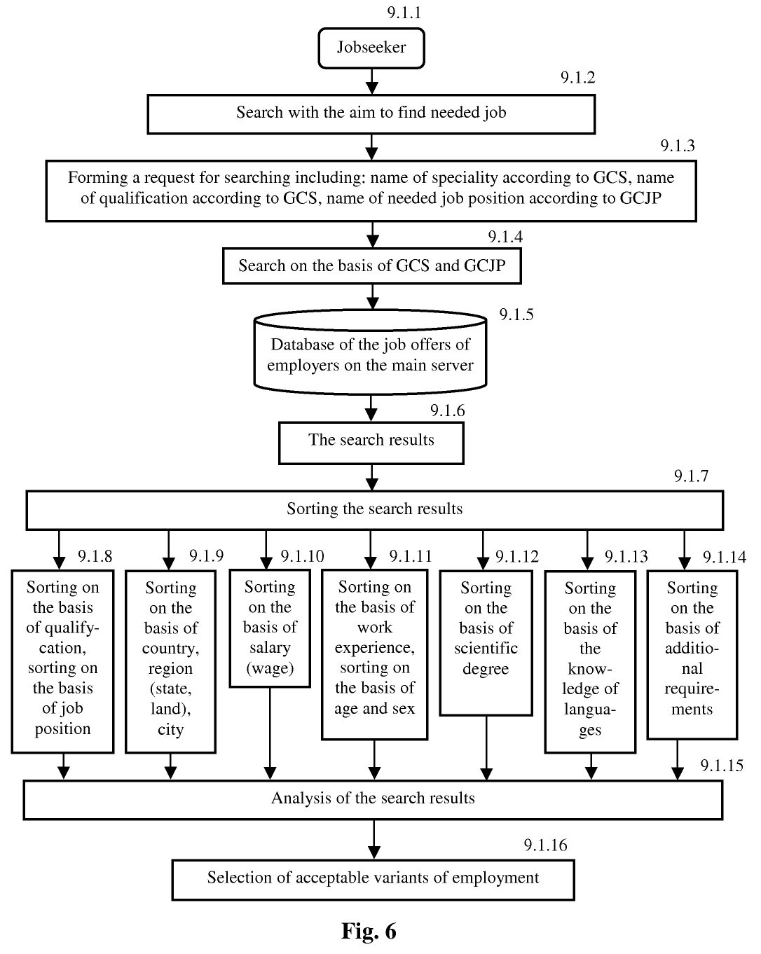

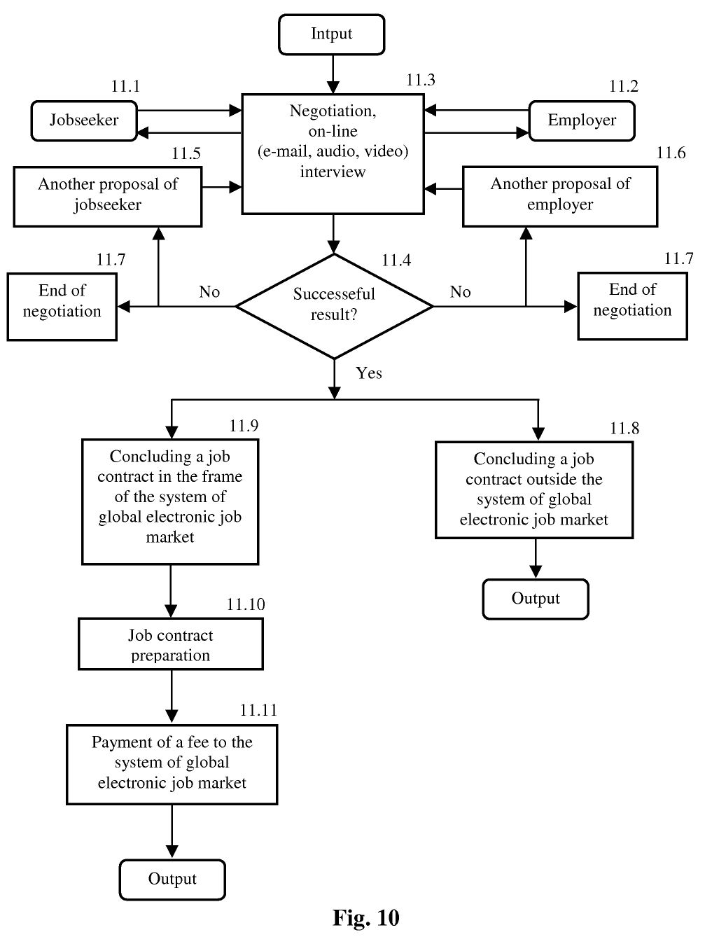

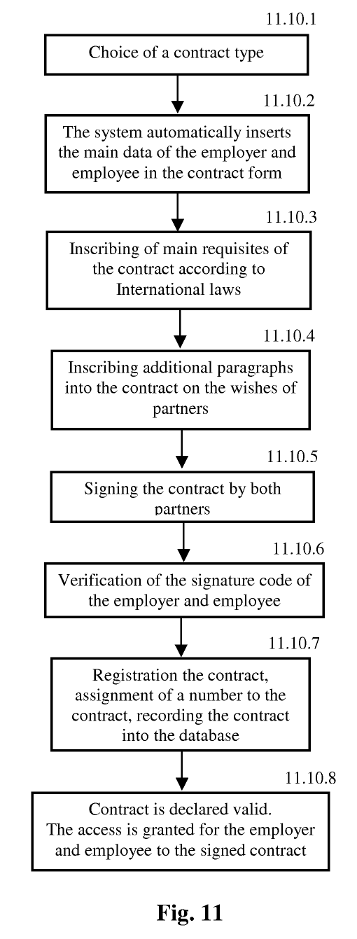

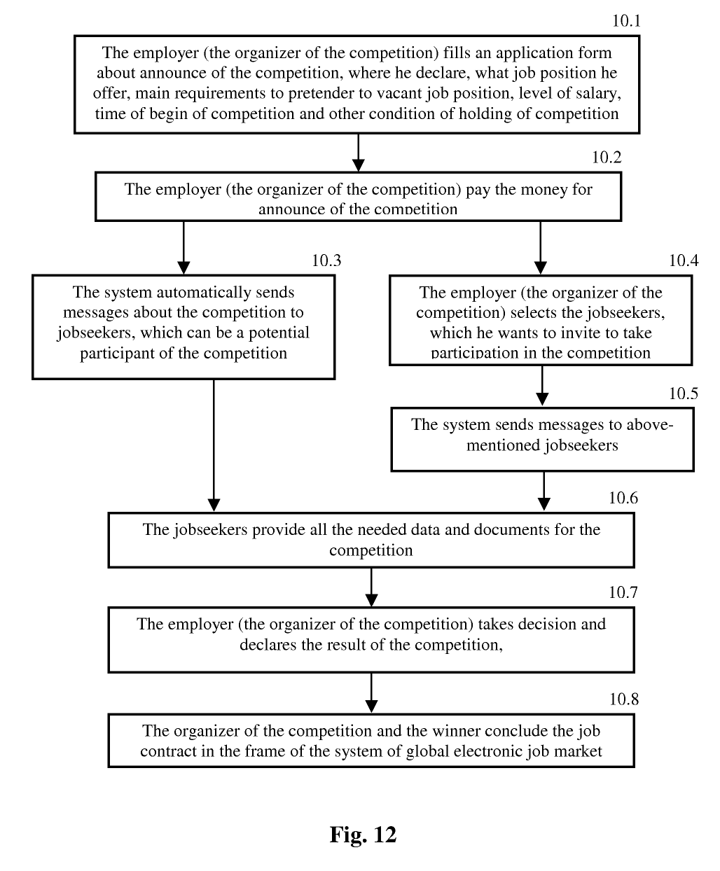

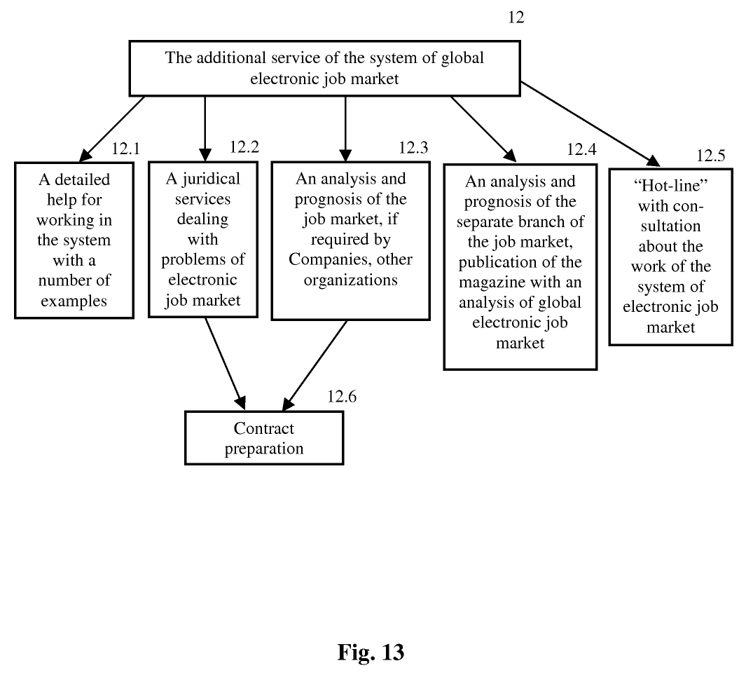

According to the invention, a method of operation of the global electronic job market (FIG. 2) includes a registration block (7—see FIG. 3), an information block (8—see FIGS. 4 and 5), a block of search and selection of a partner on the job market (9—see FIGS. 6-9), a block of competitions for job vacancies (10—see FIG. 12), a transaction block (11—see FIGS. 10-11) and a block of additional services of the system of global job market (12—see FIG. 13).

In order to register, the user must complete a registration form (7.3) (FIG. 3). This form includes data about a company (or another legal entity): a name of the company or another juridical person, a location address, an e-mail address and a telephone number. If the user is a company or another legal entity and the user wants to sign a job contract in the frame of the system of global job market or other documents of the system, he has to fill in the name and the position of his official representative, who will sign job contracts and other official documents on behalf of the company or another juridical person. The company or another legal entity has to provide an example of the official scanned signature. Companies having seals according to articles of association provide a sample of a scanned print of the seal.

If the user is an individual businessman, he/she includes his/her name in the registration form, the location address, an e-mail address and a telephone number. If the user is a private individual, he/she has to include his/her name in the registration form, the home address, an e-mail address and a telephone number. If individual users want to sign job contracts and/or other official documents in the frame of system of global job market, they have to give a scanned image of their signature.

The name of a company or another entity and the name of individual users or their registration numbers in the system will be accessible only for the registered users of the system of global job market. Other information, presented in registration forms, is considered confidential and will be unavailable. This information can be used for a job contract preparation and other official documents of the system of global job market. Upon a request of individual users, their name in the system of global job market can be replaced by their registration number in the system, for example: “Individual businessman, registration number N” or “Private individual, registration number N”.

The system allocates a user domain for a new user (7.4). In this domain all the user data will be stored. The system encodes the electronic signature and the seal of users.

Upon completion of the registration form by users, the system will send a message (7.5) to the provided e-mail address of the user with an account number, where the user must pay a registration fee. This fee is intended to discourage casual users who can potentially impede the normal operation of the system.

If no payment is received during a certain period after the registration then the system deletes the allocated user domain with all the data (7.7).

After receiving the registration fee, a letter is sent to the user with the password by an express post (7.8) with a notification of the receipt. If users require so, the system will enclose with that letter a code of signature and a code of seal.

A confirmation (7.9) will be conducted. If no confirmation is acquired either of the user's location address as specified in the application form, or the company name or the name of private person, the system locks the reserved user domain. If the user does not send a message to the system during a certain period, the system deletes a reserved user domain and returns the registration fee (7.10).

In case of confirmation of the user data, the system activates the user (7.11), his/her password and provides a registration number, which gives the user an access to the system of electronic job market.

After filling the registration form the user concludes an agreement with the system. This way the user confirms his responsibility for any breach of the national and International laws.

A user as a juridical person will be able to modify the name of the company. A user as a private person can change his/her name. But in order to activate changes the user must repeat the registration procedure.

The information block includes the following databases. There are two main databases, namely the database of jobseekers and the database of employers.

The database of jobseekers (8.1.7) (FIG. 4) consists of two parts. The first part of the database of private persons and companies, who are jobseeker agencies, is formed on the basis of data obtained during the registration procedure (8.1.2-8.1.3). This information is considered confidential.

Another part of information about jobseekers is formed by jobseekers after the registration procedure (8.1.4-8.1.6). A jobseeker fills data in the application form (8.1.4). These data include the name of his/her speciality and qualification according to Global Classification of Specialities, a scientific degree, age, sex, a work experience, a place of residence, knowledge of languages, a required job position according to Global Classification of Job Positions, or a required work place, a desired salary (wage), a permanent or a casual work needed, full-time or part-time employment needed and additional characteristics of the speciality suggested by the system. The Global Classification of Specialities (GCS) is a classification covering all the world-known names of specialities and qualification factors to them. The Global Classification of Job Positions (GCJP) is a classification covering all the world-known names of job positions of managers, job positions of specialists and clerks. A user can find any exact name of a required speciality and qualification in GCS, codes and main characteristics of any speciality. A user can find an exact name of a required job position in GCJP, its code and main characteristics.

Using the Global Classification of Specialities (GCS) and the Global Classification of Job Positions (GCJP) will provide a full correspondence of data given by jobseekers and employers.

Jobseekers, who are private persons, present a Curriculum Vitae (CV) (8.1.5). The CV can contain all the additional information, which can be interesting for employers. For example, this information can include a description of acquired education, a detailed description of the work experience, professional skills and so on. The system will provide recommendations for the preparation of CV in main languages. Information about education has a high priority. This information can include the name of speciality and qualification according to a diploma or a certificate, a name and location of an educational institution, where the jobseeker graduated from, the year of graduation, the number of the diploma or the certificate. The CV can be presented in English and in a native language. Jobseekers representing jobseeker agencies provide CVs of their clients.

Jobseekers representing jobseeker agencies can provide additional information about their agencies (8.1.6), such as the name of the agency, a location address, directions of activities, the date of foundation, the number of employees, a photograph of an office and so on.

The database of employers (8.2.6) (FIG. 5) also consists of the two parts. The first part of the database of employers is formed on the basis of data obtained during the registration procedure (8.2.2). This information is considered confidential.

Another part of information about employers is provided by employers after the registration procedure (8.2.3-8.2.5). An employer can fill the data in the application form (8.2.3). These data include a name of Company or another legal entity, a country, a location address, an activity category, the date of foundation of the Company, the number of employees, a photograph of the Company, an address of a Company's Web site and so on. If the employer is an Individual businessman, he/she provides a country, a region (state, land), an activity category, the number of employees, a location address and so on. This information is available for the registered jobseekers.

Another part of information about employers is information about offered job positions or work places. This information is formed on the basis of data provided by employers in the application form (8.2.4). These data include the name of a speciality and qualification according to Global Classification of Specialities (GCS), offered job position (for managers, specialists and clerks) according to Global Classification of Job Positions (GCJP), or a work place (for workers), a scientific degree, knowledge of languages, age, sex, a work experience, a location of the offered job (a country, a region (state, land), a city), an offered salary (wage), a permanent or a casual work offered, full-time or part-time employment offered and additional characteristics of the speciality suggested by the system.

Another part of information about employers includes additional requirements for the offered job position or the work place (8.2.5). This information can include a detailed description of the job position or the work place, required professional skills, a need for special knowledge and so on.

Jobseekers and employers can introduce a modification into the abovementioned information. Users can change or delete information about their offers from the system at any time. They can also insert new offers at any time. Every user has a possibility to change only his/her own information.

Jobseekers can perform searching with the aim to find a needed job (9.1.2) (FIG. 6). For searching for a job (9.1.3) the jobseeker has to fill a special application form where he/she specifies the name of his/her speciality and qualification according to GCS and a name of a desirable job position according to GCJP.

Searching is executed in the database of the job offers of employers (9.1.5) on the basis of Global Classification of Specialities (GCS) and Global Classification of Job Positions (GCJP) (9.1.4). Using Global Classification of Specialities (GCS) and Global Classification of Job Positions (GCJP) for searching allows acceleration of the process of searching and increases the reliability of searching.

At a request of a jobseeker, the system will give him/her all the information about offers of employers on the needed speciality, qualification and desired job position (9.1.6). If the jobseeker has no interest in a specific job position, he can leave the job position unspecified and conduct a search for the provided speciality and qualification. In this case, the system will provide the user all the information about offers of employers on the needed speciality and qualification.

Upon a completion of searching, the jobseeker gets a list of available job positions or a list of available work places on a required speciality and qualification. An every vacancy in this list will contain the following data: a country, a region (state, land), a city, where this vacancy is provided, preferred age and sex of an employee, desired working experience, desired knowledge of languages, permanent or casual work is offered, full or part-time employment is offered, preferred scientific degree, offered salary (wage). Besides, additional items, determined for some specialities only, can be specified. For example, the availability of an international driving license could be required and so on.

If the obtained list of search results is too large or, if a jobseeker has an interest in specific offers of employers only, then the jobseeker can sort the obtained search results (9.1.7).

The jobseeker can perform sorting of the obtained list or its part on the basis of the following approaches:
on the basis of factors of qualification (9.1.8),
on the basis of a required job position (9.1.8),
on the basis of a country, a region (state, land), a city (9.1.9),
on the basis of a salary (wage) (9.1.10),
on the basis of a work experience (9.1.11),
on the basis of age (9.1.11),
on the basis of sex (9.1.11),
on the basis of a scientific degree (9.1.12),
on the basis of knowledge of languages (9.1.13),
on the basis of a type of work: a permanent or a casual work (9.1.14),
on the basis of a type of employment: full-time or part-time employment (9.1.14),
on the basis of additional factors for specific specialities (9.1.14).

After the analysis of search results (9.1.15) the jobseeker can get a list of more acceptable variants of employment (9.1.16).

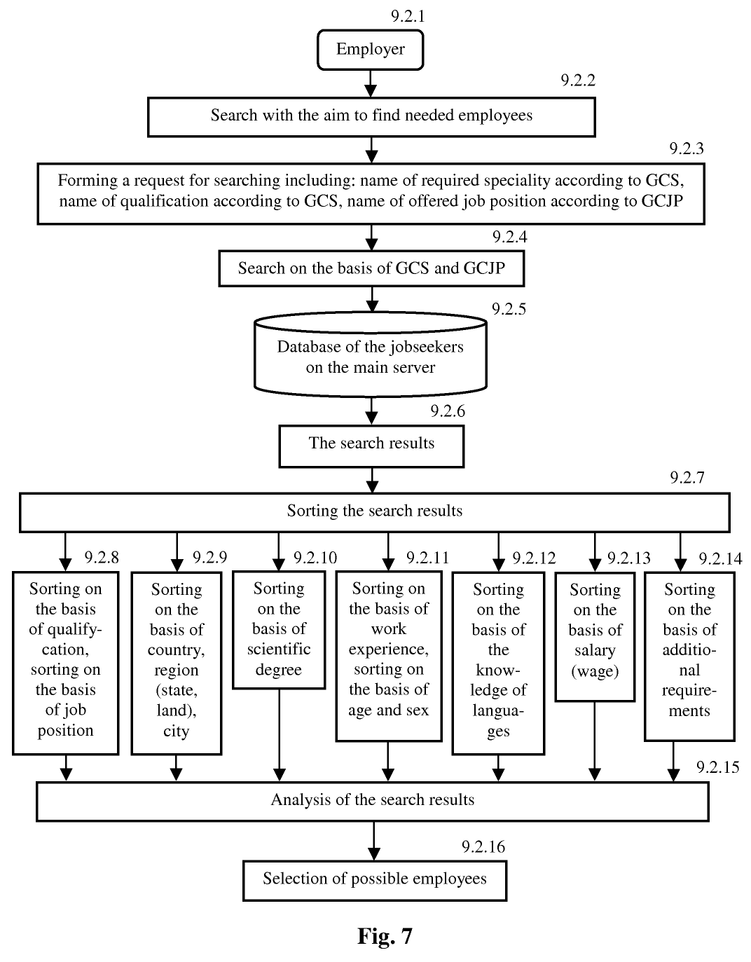

Employers can conduct searching with the aim to find needed employees (9.2.2) (FIG. 7). For a realisation of a search for employees (9.2.3) the employer has to fill a special application form where he specifies a name of a required speciality and a qualification of an employee according to GCS and a name of an offered job position according to GCJP.

Searching is executed in the database of the jobseekers (9.2.5) on the basis of Global Classification of Specialities (GCS) and Global Classification of Job Positions (GCJP) (9.2.4).

Upon a request of the employer, the system will give him all the information about the offers of jobseekers on the needed speciality, qualification and the offered job position (9.2.6). If the employer wants to get a result list without indicating a job position, he can leave the job position unspecified and conduct a search for the provided speciality and qualification. In this case, the system will provide the user all the information about the offers of jobseekers on the needed speciality and qualification.

An every offer of jobseekers in this list will contain next data: the desired job position of jobseekers, the working experience of jobseekers, knowledge of languages, a permanent or a casual work is needed, full-time or part-time employment is needed, availability of a scientific degree, a desired salary (wage), age and sex of jobseeker, a country, a region (state, land), and a city of residence of jobseekers. Additional factors, which are defined for specific specialities only, will also be provided.

The employer can make sorting of the obtained list or a part of it on the basis of the following approaches:
on the basis of factors of qualification (9.2.8),
on the basis of a required job position (9.2.8),
on the basis of a country, a region (state, land), a city (9.2.9),
on the basis of a scientific degree (9.2.10),
on the basis of a work experience (9.2.11),
on the basis of age (9.2.11),
on the basis of sex (9.2.11),
on the basis of knowledge of languages (9.2.12),
on the basis of a required salary (wage) (9.2.13),
on the basis of a required type of work: a permanent or a casual work (9.2.14),
on the basis of a required type of employment: full-time or part-time employment (9.2.14),
on the basis of additional factors of specific specialities (9.2.14).

After the analysis of search results (9.2.15) the employer can get a list of more acceptable candidates for employment (9.2.16).

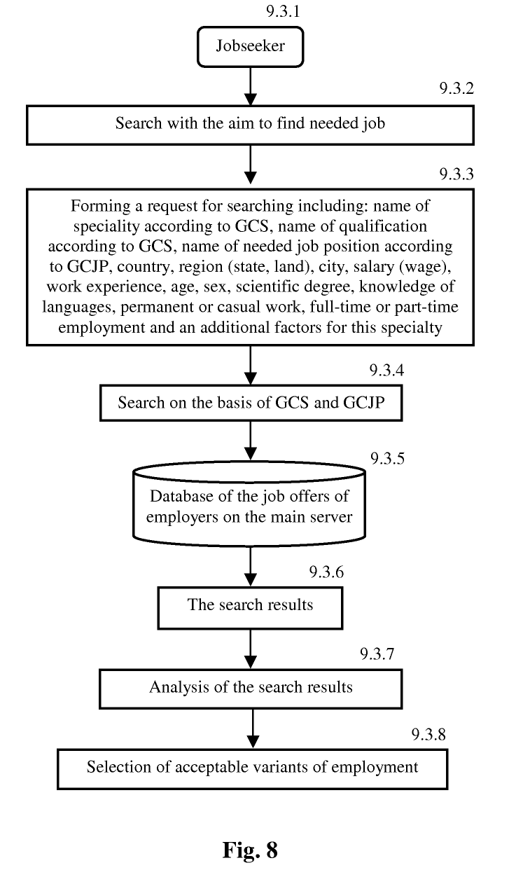

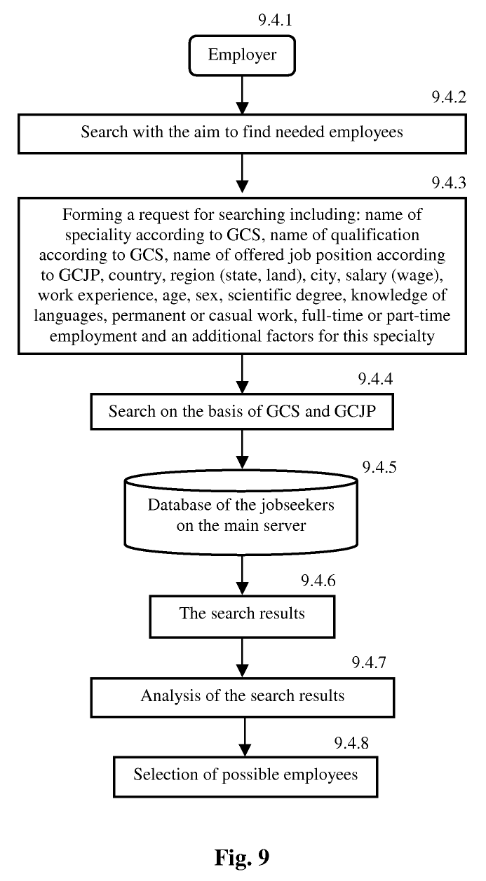

Users can execute search on the basis of an expanded request (FIG. 8, FIG. 9). For such a search for a needed job a jobseeker must specify in the application form all the desirable data (9.3.3): the name of a speciality according to GCS, the name of qualification according to GCS, the name of the needed job position according to GCJP, a country, a region (state, land), a city, a salary (wage), a work experience, age, sex, a scientific degree, knowledge of languages, a permanent or a casual work, full-time or part-time employment and additional factors for this speciality.

Searching is executed in the database of the job offers (9.3.5) on the basis of Global Classification of Specialities (GCS) and Global Classification of Job Positions (GCJP) (9.3.4). Upon completion of the search the system provides a list of acceptable vacancies (9.3.6) or informs that there are no acceptable variants of employment found.

The jobseeker can change initial data (9.3.3) for search and repeat the search. The jobseeker is also allowed to specify only a part of initial data for searching. For example, if he/she does not specify a desirable salary (wage), then he/she will get a longer list of available vacancies because there is no limitation on a salary (wage). If the jobseeker does not specify a desirable job position, then he/she will get again a longer list of vacancies with all the offered job positions and so on.

The search on the basis of an expanded request can be carried out in the specified time by jobseeker and be repeated a specified number of times.

For a search on the basis of an expanded request of needed employees an employer must specify all the desirable data in the application form (9.4.3): a name of a speciality according to GCS, a name of qualification according to GCS, a name of an offered job position according to GCJP, a country, a region (state, land), a city, a salary (wage), a work experience, age, sex, a scientific degree, knowledge of languages, a permanent or a casual work, full-time or part-time employment and additional factors for this speciality.

Searching is executed in the database of the jobseekers (9.4.5) on the basis of Global Classification of Specialities (GCS) and Global Classification of Job Positions (GCJP) (9.4.4). Upon completion of the search the system provides a list of offers from jobseekers (9.4.6) or informs that no jobseekers fitting the requirements are found.

The employer can change the initial data (9.4.3) for the search and repeat it. The employer can also specify only a part of initial data for searching.

The search on the basis of expanded request can be carried out in the specified time by the employer and is repeated a specified number of times.

FIG. 10 describes the transaction block. Upon definition of potential partners in the system of global job market, users can engage into negotiations on a possible conclusion of job contracts. They can negotiate on-line using provided audio or video services or internal e-mail of the system. Audio or video can be conducted through a special window in the system. Negotiations can be conducted as an exchange of text or e-mail messages, or via telephone (11.3). If the result of negotiations is successful, the parties can prepare a job contract. The job contract can be concluded in the frame of the system (11.9) or outside the system (11.8). If the job contract is concluded in the frame of the system, the system records a debt to one of the partners, who will be named in the contract as the payer of the fee to the system.

FIG. 11 describes a process of preparing and concluding the job contract. The employer and the jobseeker, which decide to conclude a job contract in the frame of system of global job market, are able to choose a suitable type of the contract (11.10.1). The system proposes different kinds of standard job contracts. Standard job contracts differ depending on: who will sign a contract on the employer side, speciality of the employer, period of employment (for a specified time or permanent) and so on. The standard job contracts are prepared according to the International legal regulations. The standard job contracts include the main requisites (11.10.3), which are needed to be inscribed in the contract. The contract will not be registered in the system until these data is inscribed. The system automatically inserts the main data about the employer and the employee in the contract form (11.10.2). After that the partners can introduce additional paragraphs into the contract, if they wish so (11.10.4). The system provides free recommendations of lawyers of the system about additional paragraphs of a job contract. Then the partners have to decide who will pay the fee to the system, and mention that in the contract. After that the partners insert electronic signature into the contract through entering corresponding codes in the special fields (11.10.5). The partner having a seal according to the article of associations must input the seal code in the determined place. After that the system verifies the introduced signature and seal codes (11.10.6). If all the data is valid, the system places scanned signatures and seals of each party into the determined places in the contract. After that the system registers the contract, assigns the number to the contract and records the contract into the database (11.10.7). After that the contract registration is declared valid. The both parties are granted an access to the contract (11.10.8) in order to be able to print it, store it in another location and so on.

The contract will be registered automatically only in case, if it was signed by the both parties, so none of the parties can reject the fact, that the contract was signed. This procedure increases the reliability of the contract. The system can confirm the conclusion of the contract in case of a conflict situation.

FIG. 12 describes the procedure of holding a competition for job vacancies by employers. An employer (the organizer of the competition) fills the application form for announcement of the competition, where he declares what job position he offers, main requirements to a pretender for the vacant job position, a level of salary, time of beginning of the competition and other conditions of holding the competition (10.1). Then the employer, as the organizer of the competition, pays the money for the announcement of the competition (10.2). There are two ways for notifying potential participants about the competition. In the first way the system automatically sends messages about the competition to potential participants on the basis of declared parameters via internal e-mail (10.3). In the second way, the employer (the organizer of the competition) invites jobseekers himself (10.4). Then the system sends messages to invitees via internal e-mail (10.5). The potential participants of the competition are required to send all the needed data and documents for the competition to the organizer of the competition (10.6). After having analyzed these data the organizer of the competition takes a decision (10.7). Then the organizer declares the result of the competition, which he sends to the participants of the competition via internal e-mail of the system (10.7). Finally, the organizer of the competition and the winner of the competition conclude a job contract in the frame of the system (10.8).

FIG. 13 describes additional services of the system of electronic job market. These services include:
a detailed help for working in the system of electronic job market with a number of examples (12.1),
a juridical services dealing with problems of electronic job market (12.2),
an analysis and prognosis of the job market, if required by Companies, other organizations and individuals (12.3),
an analysis and prognosis of specific branches of the job market (12.4),
a publication of the magazine with an analysis of the global electronic job market (12.4), and
“Hot-line” with consultation about the work of the system of electronic job market (12.5).

What is claimed is:

1. A system of global electronic job market via the Internet for users, including jobseekers and employers as equitable job market participants, comprising:
a host server including a database and a Web site or a network communication program with a multi-language support; and
user computers capable of communicating with the host server;
wherein the host server registers the users, provides information regarding requests of jobseekers for job searching and offers from employers to the user computers, searches and selects job market partners, holds competitions for job vacancies, conducts transactions, and additional services of the system of global electronic job market.

2. A method of operation of global electronic job market for jobseekers and employers via the Internet, comprising
registering the jobseekers and the employers;
providing information regarding requests of jobseekers for job searching and offers from employers to the registered jobseekers and employers;
selecting job market partners based on the provided information;
holding competitions for job vacancies;
conducting transactions between the job market partners; and
providing the additional services of the system of global job market.

3. The method according to claim 2, wherein the registration of the jobseekers and employers comprises filling a registration form for a subsequent check of data provided by a user into this form and using this data for a contract preparation or preparation of other official documents.

4. The method according to claim 2, wherein providing information regarding requests of jobseekers for job searching and offers of employers comprises providing information in accordance with Global Classification of Specialities (GCS), covering all the world known names of specialities and factors of qualifications for them, and regarding Global Classification of Job Positions (GCJP), covering all the world known names of job positions of managers, job positions of specialists and clerks.

5. The method according to claim 2, wherein selecting job market partners comprises searching for a job by jobseekers on the basis of Global Classification of Specialities (GCS) and Global Classification of Job Positions (GCJP).

6. The method according to claim 2, wherein selecting job market partners comprises searching for employees by employers on the basis of Global Classification of Specialities (GCS) and Global Classification of Job Positions (GCJP).

7. The method according to claim 2, wherein conducting transactions comprises:
conducting negotiations;
closing of a contract in case of a successful negotiation in the frame of the system of global electronic job market or out of it.

8. The method according to claim 7, wherein closing of the contract in the frame of the system of global electronic job market in case of a successful negotiation comprises:
choosing a standard form of a contract proposed by the system of global electronic job market;
automatic filling main data about job market partners into the form of the contract;
filling main requisites into the contract according to International legal regulations;
filling additional paragraphs into the contract if the user desires so;
signing the contract with the electronic signature;
setting the contract with an electronic seal for users having a seal according to articles of associations;
verifying codes of the electronic signature and seal;
automatic setting scanned signatures and seals of both parties in a specified location of the contract;
automatic registration of a contract and storing the contract into the database of confidential information without a possibility to insert any one-sided changes into the contract;
making the contract accessible for every party.

9. The method according to claim 2, wherein holding a competition for job vacancies by an employer, comprises:
filling the application form for an announcement of the competition, where the employer declares which job position he offers, main requirements for a seeker to the vacant job position, the level of salary, start time of the competition and other conditions of holding the competition;
notification of potential participants about the competition carried out either through automatic sending messages about the competition to the potential participants selected on the basis of the declared parameters, or by automatic sending messages about the competition to jobseekers selected by the organizer of the competition;
providing all the needed data and documents for the competition by jobseekers;
declaration of a result of the competition by means of publishing this result on a special page of the system of global electronic job market exclusively available for the participants of the competition; and
conclusion of the contract in the frame of the system of global electronic job market between the organizer and the winner of the competition.

10. The method according to claim 2, further providing additional services of the system of global electronic job market comprising:
detailed help for working in the system of electronic job market with a number of examples;
juridical services for dealing with problems of electronic job market;
analysis and prognosis of the job market, if requested by Companies, other organizations and individuals;
analysis and prognosis of a specific branch of the job market;
publication of the magazine with an analysis of the global electronic job market; and
“Hot-line” with consultation about the work of the system of electronic job market.

11. A method of registration into the system of global electronic job market, comprising:
filling a registration form for subsequent check of data provided by a user into the registration form and for using the data for a contract preparation and for preparation of other official documents;
including the electronic signature and the seal into the registration form; and
encoding the electronic signature and the seal.

12. A method of providing information for the system of global electronic job market, comprising:
creating the database of jobseekers;
creating the database of employers.

13. The method according to claim 12, wherein creating the database of jobseekers comprises:
creating a database of confidential information for preparation of contracts and other official documents for individuals, including the name, a home address, an e-mail address, a phone number and a sample of the signature;
creating a database of confidential information for preparation of contracts and other official documents for companies, who are jobseeker agencies, including the name of the company, the official address, an e-mail address, a phone number, a sample of the signature of an official representative and the seal;
creating a database of information about jobseekers comprising a name of his/her speciality, a qualification according to Global Classification of Specialities (GCS), a scientific degree, age, sex, a work experience, a place of residence, knowledge of languages, a required job position, according to Global Classification of Job Positions (GCJP), or a required work place, a desired salary (wage), a permanent or a casual work needed, full or part-time employment needed and additional characteristics of a speciality suggested by the system of global electronic job market;
creating a database of CV's;
creating a database of additional information about jobseeker agencies including the legal name, location address, directions of activities, date of foundation, number of employees, photograph of an office.

14. The method according to claim 12, wherein creating a database of employers comprises:
creating a database of confidential information for preparation of contracts and other official documents for employers including the Company name, a location address, an e-mail address, a phone number, a sample of a signature of a responsible person who can sign a contract, a sample of a seal;
creating a database of additional information about employers including an activity category, a date of foundation of the Company, a number of employees, a location address, a picture of the Company, a Web site of the Company;
creating a database of information about offered job positions or work places comprising a name of a speciality and qualification according to Global Classification of Specialities (GCS), an offered job position, according to Global Classification of Job Positions (GCJP), or a work place, a scientific degree, knowledge of languages, age, sex, a work experience, a place of location of the offered job, an offered salary (wage), a permanent or a casual work offered, full or part-time employment offered and additional characteristics of the speciality suggested by the system of global electronic job market;
creating a database of additional information about offered job positions and work places and additional demands for a future employee.

15. A method of searching for a required job by a jobseeker, comprising:
searching on the basis of a simple request comprising a name of his/her speciality and qualification according to Global Classification of Specialities (GCS) and a name of a desired job position according to Global Classification of Job Positions (GCJP); and
searching on the basis of an expanded request comprising a name of his/her speciality according to Global Classification of Specialities (GCS), a name of his/her qualification according to GCS, a name of a needed job position according to Global Classification of Job Positions (GCJP), a country, a region (state, land), a city, a salary (wage), a work experience, age, sex, a scientific degree, knowledge of languages, a permanent or a casual work, full-time or part-time employment and additional factors for his/her specialty.

16. The method according to claim 15, wherein searching on the basis of a simple request comprises: searching on a basis of Global Classification of Specialities (GCS) and Global Classification of Job Positions (GCJP); and sorting of obtained search results, wherein this sorting comprises:
sorting on a basis of factors of qualification;
sorting on a basis of a required job position;
sorting on a basis of a country, a region (state, land), a city;
sorting on a basis of a salary (wage);
sorting on a basis of a work experience;
sorting on a basis of age;
sorting on a basis of sex;
sorting on a basis of a scientific degree;
sorting on a basis of knowledge of languages;
sorting on a basis of a type of work: a permanent or a casual work;
sorting of search results on a basis of a type of employment: full or part-time employment; and
sorting of search results on a basis of additional factors of specialities.

17. A method of searching for required employees by an employer, comprising:
searching on the basis of a simple request comprising a name of required speciality and qualification of employee according to Global Classification of Specialities (GCS) and a name of an offered job position according to Global Classification of Job Positions (GCJP); and
searching on the basis of an expanded request comprising a name of a speciality according to Global Classification of Specialities (GCS), a name of qualification according to GCS, a name of an offered job position according to Global Classification of Job Positions (GCJP), a country, a region (state, land), a city, a salary (wage), a work experience, age, sex, a scientific degree, knowledge of languages, a permanent or a casual work, full-time or part-time employment and additional factors for this speciality.

18. The method according to claim 17, wherein searching on the basis of a simple request comprises: searching on a basis of Global Classification of Specialities (GCS) and Global Classification of Job Positions (GCJP); and sorting of obtained search results, wherein this sorting comprises:
sorting on a basis of factors of qualification;
sorting on a basis of an required job position;
sorting on a basis of a country, a region (state, land), a city;
sorting on a basis of a scientific degree;
sorting on a basis of a work experience;
sorting on a basis of age;
sorting on a basis of sex;
sorting on a basis of knowledge of languages;
sorting on a basis of an required salary (wage);
sorting on a basis of a type of work: a permanent or a casual work;
sorting of search results on a basis of a type of employment: full or part-time employment; and
sorting of search results on a basis of additional factors of specialities.
